(19) United States
(12) Patent Application Publication
(10) Pub. No.: US 2020/0320251 A1
(43) Pub. Date: Oct. 8, 2020

(54) SYSTEM AND METHOD FOR ADDING DATA TO WEB FORMS

(71) Applicant: Amanda Jean Morse, Phoenix, AZ (US)

(72) Inventor: Amanda Jean Morse, Phoenix, AZ (US)

(21) Appl. No.: 16/841,560

(22) Filed: Apr. 6, 2020

Related U.S. Application Data
(60) Provisional application No. 62/830,369, filed on Apr. 5, 2019.

(51) Int. Cl. G06F 40/174

(52) U.S. Cl. CPC G06F 40/174; G06F 3/0482

(57) ABSTRACT

A system for adding data to a web form on a website is disclosed. The system comprises an internal or external data storage center having a server, a processor in communication with the server, a database, and a computing device. The processor is configured to execute a set of instructions stored in a memory. The database is configured to store data related to a user. The computing device is configured to access the server via a network and a browser extension for receiving data from the database, thereby automatically adding data and filling the web forms from one website to another website by minimizing user interventions. The browser extension is configured to display a menu with multiple options. The user selects an option from the menu displayed on the computing device to copy data from a browser window/tab and fill the web form displayed in another browser window/tab.

### CROSS REFERENCE TO RELATED APPLICATION

The present application claims the benefit of U.S. Patent Application No. 62/830,369 filed Apr. 5, 2019, the contents of which is hereby incorporated by reference.

### BACKGROUND OF THE INVENTION

### A. Technical Field

The present invention generally relates to a system and method for filling web forms. More specifically, the present invention relates to a system and method for automatically adding data and filling web forms with a text, images and files.

### B. Description of Related Art

A variety of client and server software is freely available. Most clients and servers support “forms” which allow the user to enter arbitrary text as well as selecting options from customizable menus and on/off switches. As more business is transacted on the Web, forms are proliferating. The forms may include forms for requesting further information, for ordering items from the Web, for registering for a Web site, etc.

Currently, if a user wants to post information on products, services or advertisements on the internet in a pre-existing platform, for example in e-commerce on the marketplace eBay, the user typically fills out a form where fields allow them to enter images, a title, a description, and if relevant fields for information such as price, brand, color, etc. These forms are relatively simple to fill out if posting or listing on one place only. But when the user wants to add the same data to multiple web sites on the internet, for example on both marketplaces eBay and Etsy, it becomes repetitive and tedious to fill out forms with the same information multiple times.

The solution to streamline this process has been to use Application Programming Interface (API) coding. In basic terms, APIs just allow applications to communicate with one another. The limitation here is both websites, the origin where the data is stored and the destination where the data would be sent to, need to be coded to send and receive API communications. Many websites do not have API or API available for outside developers to interact with as is currently the case with marketplaces like Poshmark and Mercari, so in these situations APIs are not able to send data to these sites. Further, keeping up with API coding updates and changes on sites that have APIs is expensive and time consuming.

A prior art US20070256005 assigned to Schneider; James E., describes about a field-link autofill in which electronic form filling enable user to enter data into source form and transform them to any number of electronic target forms. The data fields accept input from a small discrete set and the radio-button selection actions are defined by the HTML. The software application is installed on the computer systems by potential users through the internet. The extension with association information is stored/updated and it the information is received from the extension. The users are directed through a series of forms that allow users to manage accounts, view statistics, SEMCAT to fill forms, and extension must have the initial URL for each provider-form to be filled. The SEMCAT extension is labelled with an icon where the user clicks and navigates to the context menu under the pointing-device's location to set and unset options in the extensions. The extension places a button adjacent to each fillable field that allows the user to invoke SEMCAT as it applies to that field.

Another prior art US20140258828 assigned to Lymer; Brent., describes about an autofill browser extension or Smartphone app which provides pick-place webform autofill for secure storage and autofill populating of webforms with personal user information. The system has JavaScript, HTML to process accurate predictive auto-filling. The fillable webforms resulting from JavaScript executions, select fields, drop down lists, other pop-up's, and radio-buttons are choices that are typically implemented and presented in non-standard ways by web sites. The pick-and-place autofill app is downloaded and installed on the mobile device. The user navigates to the shopping cart checkout, so pick-and-place process displays the webform simultaneously with the menu selected by process, and user selects the right answer to fill the question and drags/drop it or pick/place it in the corresponding spot in the webform.

In light of the above-mentioned problems, there is a need for a system and method to streamline the process of getting data from one website or application to the other website.

### SUMMARY OF THE INVENTION

The present invention generally discloses a system and method for filling web forms. Further, the present invention discloses a system and method for automatically adding data and filling web forms with a text, images and files.

According to the present invention, the system is configured to add data to web forms from one website or application to another website. The system comprises an internal or external data storage center, a server, and a database. In one embodiment, a user could access the system using a computing device, for example, a computer or a smartphone via a network. In one embodiment, the system could be an extension, which is installed by the user via the computing device that is connected to the network. The extension could be stored in an internal or external data storage center, which comprises a server where the correct file may be identified by an entry in the database. In one embodiment, the database is configured to store information such as a name, e-mail address, credit card numbers, social security number, etc.

In one embodiment, the computing device is enabled to access the server via the network. In one embodiment, the computing device is at least one of, but not limited to, a smartphone, a laptop, a computer, a tablet, a mobile phone, or other suitable mobile and/or handheld electronic devices. In one embodiment, the computing device comprises a storage medium in communication with the network to access the server. In an embodiment, the network could be, but not limited to, a Wi-Fi, a WiMAX network, a local area network (LAN), a wide area network (WAN), and a wireless local area network (WLAN). In one embodiment, the computing device is in communication with the server, wherein such communication is established via a software application, a browser extension, a mobile application, a browser, an OS, and/or any combination thereof.

In one embodiment, the server comprises a processor and a memory in communication with the processor. In one embodiment, the memory is configured to store a set of instruction executable by the processor. In one embodiment, the server could be operated as a single computer. In some embodiments, the computer could be a touchscreen and/or non-touchscreen and adopted to run on any type of OS, such as iOS™, Windows™ Android™, Unix™, Linux™ and/or others. In one embodiment, the server 106 could be a cloud server.

In one embodiment, a method to download and install the browser extension in an exemplary embodiment of the present invention is disclosed. At one step, the user accesses the computing device with an internet connection. In an exemplary embodiment, the computing device could be, but not limited to, a computer or a laptop. In some embodiments, the computing device is at least one of, but not limited to, a smartphone, a tablet, a mobile phone, or other suitable mobile and/or handheld electronic devices. At another step, an internet browser is opened on the computing device by the user via a network, for example, a wireless local area network (WLAN). In an exemplary embodiment, the internet browser could be, but not limited to, Google chrome. At another step, the user navigates the storage location where the user could find browser extension installation files by either typing a URL or web address in the internet browser or by accessing the browser extension directory. Further at another step, the user installs and activates the browser extension on the computing device.

In one embodiment, a method to retrieve data from a web page or a form and fill another new web page or web form with the retrieve data is disclosed. At one step, the user accesses the computing device that has installed browser extension with an internet connection. In an exemplary embodiment, the computing device could be, but not limited to, a computer or a laptop. At another step, an internet browser is opened on the computing device by the user via the network, for example, a wireless local area network (WLAN) or Wi-Fi. In an exemplary embodiment, the internet browser could be, but not limited to, Google chrome. At another step, the user navigates a website page or a web form to copy data using the computing device via the network. At another step, the user could open another new browser window and navigates a new website page or a web form, for example, eBay where data needs to be entered or filled. At another step, the user clicks on an icon or image of the browser extension to display a menu with multiple options. Further at another step, the user selects an option that will then copy data from the internet browser window that holds data and paste on the web page or web form which is displayed on another website page or web form where data needs to be filled by the user with minimum user interventions.

In one embodiment, a method to retrieve data from a web page or a form and fill new web pages or web forms on several browsers with the retrieve data is disclosed. At one step, the user accesses the computing device that has installed browser extension with an internet connection. At another step, a window or a tab is opened on the internet browser using the computing device by the user via the network, for example, a wireless local area network (WLAN) or Wi-Fi. In an exemplary embodiment, the internet browser could be, but not limited to, Google chrome. At another step, the user navigates a website page or a web form to retrieve or copy data using the computing device via the network. At another step, several new windows or tabs are opened on the internet browser by the user. At another step, the user navigates a different website page or tab in each new browser window or tab and that may also display a web form where data needs to be filled. In an exemplary embodiment, the web pages such as, but not limited to, eBay, Etsy, etc. At another step, the user clicks on an icon or image of the browser extension to display a menu with multiple options. Further at another step, the user selects an option that will then copy data from the internet browser window that holds data and paste on the website page or web form which is displayed on the several website pages or web forms where data needs to be entered or filled by the user with minimum user interventions.

Other objects, features and advantages of the present invention will become apparent from the following detailed description. It should be understood, however, that the detailed description and the specific examples, while indicating specific embodiments of the invention, are given by way of illustration only, since various changes and modifications within the spirit and scope of the invention will become apparent to those skilled in the art from this detailed description.

### BRIEF DESCRIPTION OF DRAWINGS

The foregoing summary, as well as the following detailed description of the invention, is better understood when read in conjunction with the appended drawings. For the purpose of illustrating the invention, exemplary constructions of the invention are shown in the drawings. However, the invention is not limited to the specific methods and structures disclosed herein. The description of a method step or a structure referenced by a numeral in a drawing is applicable to the description of that method step or structure shown by that same numeral in any subsequent drawing herein.

FIG. 1 shows a block diagram of an environment of a system for adding data to web forms in an embodiment of the present invention.

FIG. 2 shows a flowchart of a method to download and install a browser extension in one embodiment of the present invention.

FIG. 3 shows a flowchart of a method to retrieve data from a web page or a form and fill another new web page or web form with the retrieve data in one embodiment of the present invention.

FIG. 4 shows a flowchart of a method to retrieve data from a web page or a form and fill new web pages or web forms on several browsers with the retrieve data in one embodiment of the present invention.

### DETAILED DESCRIPTION OF EMBODIMENTS

A description of embodiments of the present invention will now be given with reference to the Figures. It is expected that the present invention may be embodied in other specific forms without departing from its spirit or essential characteristics. The described embodiments are to be considered in all respects only as illustrative and not restrictive.

In modern coding, one solution is to use the coding language JavaScript to accomplish this. Modern web browsers are all built to read the coding languages CSS, HTML and JavaScript. JavaScript is responsible for web page actions, and can change text on buttons, click buttons, add data to fields, and perform actions that otherwise would need a human to execute. Google Chrome browser for example allows developers to create browser extensions that, using JavaScript or a combination of CSS, HTML and JavaScript, will change or update web pages based on user needs with minimal or no user intervention.

Embodiments of the present invention include, but are not limited to the following detailed description of drawings. The included drawings show examples of the invention as a browser extension created, designed and/or coded to interact with the web forms of online sites, to copy data that has been previously entered and is now displayed on one web page or web form and paste this data into the appropriate fields of another website's online form, where data can include, but not be limited to, text, html markup or tags, images, videos, graphics, other types of files, and any other relevant data type as could be found online or entered into an online form.

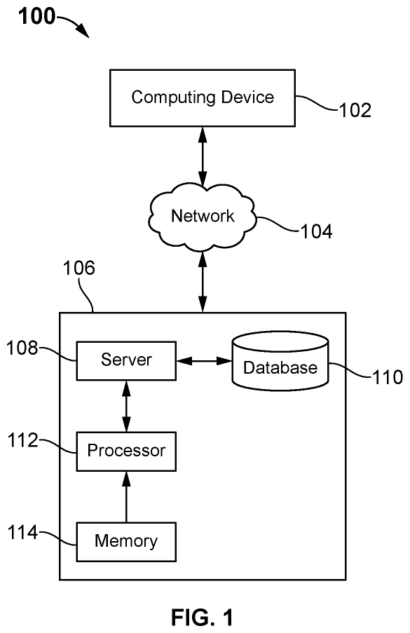

Referring to FIG. 1, an environment of a system 100 for adding data to web forms, according to one embodiment of the present invention. In one embodiment, the system 100 is configured to add data to web forms from one website or application to another website. The system 100 comprises an internal or external data storage center 106, a server 108, and a database 110. In one embodiment, a user could access the system 100 using a computing device 102, for example, a computer or a smartphone via a network 104. In one embodiment, the system 100 could be an extension, which is installed by the user via the computing device 102 that is connected to the network 104. The extension could be stored in an internal or external data storage center 106, which comprises a server 108 where the correct file may be identified by an entry in the database 110. In one embodiment, the database 110 is configured to store information such as a name, e-mail address, credit card numbers, social security number, etc.

In one embodiment, the computing device 102 is enabled to access the server 108 via the network 104. In one embodiment, the computing device 102 is at least one of, but not limited to, a smartphone, a laptop, a computer, a tablet, a mobile phone, or other suitable mobile and/or handheld electronic devices. In one embodiment, the computing device 102 comprises a storage medium in communication with the network 104 to access the server 108. In an embodiment, the network 104 could be, but not limited to, a Wi-Fi, a WiMAX network, a local area network (LAN), a wide area network (WAN), and a wireless local area network (WLAN). In one embodiment, the computing device 102 is in communication with the server 108, wherein such communication is established via a software application, a browser extension, a mobile application, a browser, an OS, and/or any combination thereof. In one embodiment, the computing device 102 is configured to access the server 108 via the network 104 and a browser extension for receiving data and automatically adding the retrieved data and filling the web forms with a text, images and files from one website to another website by the user with minimum user interventions.

In one embodiment, the server 108 comprises a processor 114 and a memory 116 in communication with the processor 114. In one embodiment, the memory 116 is configured to store a set of instruction executable by the processor 114. In one embodiment, the server 108 could be operated as a single computer. In some embodiments, the computer could be a touchscreen and/or non-touchscreen and adopted to run on any type of OS, such as iOS™, Windows™, Android™, Unix™, Linux™ and/or others. In one embodiment, the server 106 could be a cloud server.

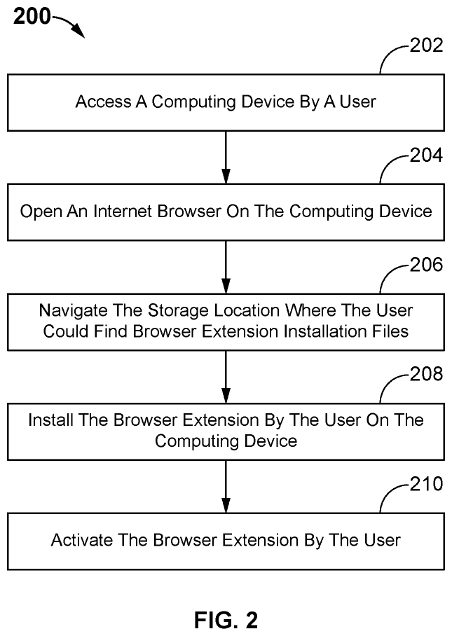

Referring to FIG. 2, —in an exemplary embodiment of the present invention is disclosed. At step 202, the user accesses the computing device 102 (shown in FIG. 1) with an internet connection. In an exemplary embodiment, the computing device 102 could be, but not limited to, a computer or a laptop. In some embodiments, the computing device 102 is at least one of, but not limited to, a smartphone, a tablet, a mobile phone, or other suitable mobile and/or handheld electronic devices. At step 204, an internet browser is opened on the computing device 102 by the user via a network 104 (shown in FIG. 1), for example, a wireless local area network (WLAN). In an exemplary embodiment, the internet browser could be, but not limited to, Google chrome. At step 206, the user navigates the storage location where the user could find browser extension installation files by either typing a URL or web address in the internet browser or by accessing the browser extension directory. At steps 208 and 210, the user installs and activates the browser extension on the computing device 102.

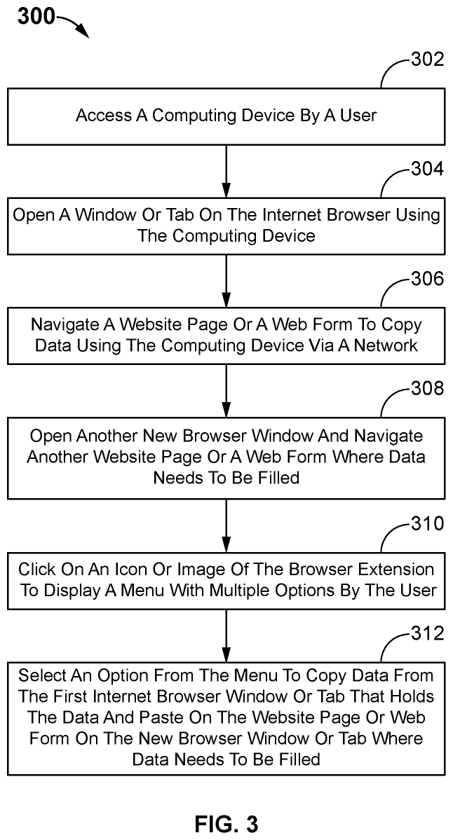

Referring to FIG. 3, a flowchart of a method 300 to retrieve data from a web page or a form and fill another new web page or web form with the retrieve data is disclosed. At step 302, the user accesses the computing device 102 that has installed browser extension with an internet connection. In an exemplary embodiment, the computing device 102 could be, but not limited to, a computer or a laptop. At step 304, an internet browser is opened on the computing device 102 by the user via the network 104, for example, a wireless local area network (WLAN) or Wi-Fi. In an exemplary embodiment, the internet browser could be, but not limited to, Google chrome. At step 306, the user navigates a website page or a web form to copy data using the computing device 102 via the network 104. At step 308, the user could open another new browser window and navigates a new website page or a web form, for example, eBay where data needs to be entered or filled. At step 310, the user clicks on an icon or image of the browser extension to display a menu with multiple options. Further at step 312, the user selects an option that will then copy data from the internet browser window that holds data and paste on the web page or web form which is displayed on another website page or web form where data needs to be filled by the user with minimum user interventions.

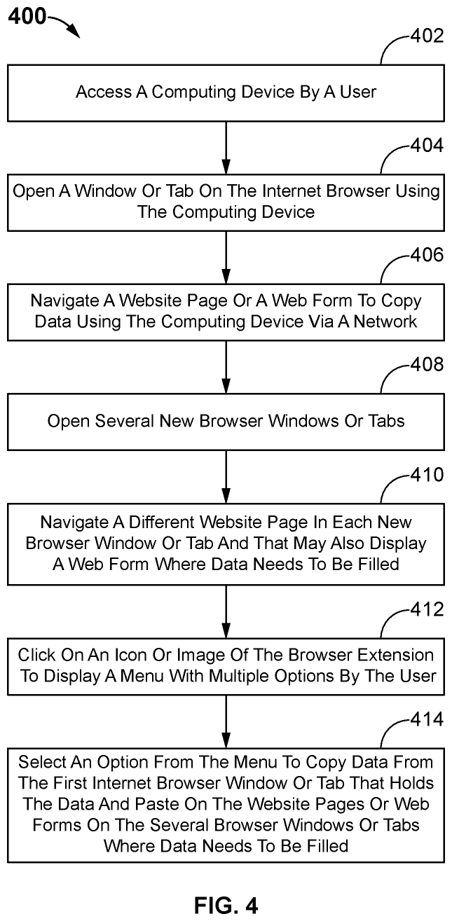

Referring to FIG. 4, a flowchart of a method 400 to retrieve data from a web page or a form and fill new web pages or web forms on several browsers with the retrieve data is disclosed. At step 402, the user accesses the computing device 102 that has installed browser extension with an internet connection. At step 404, a window or a tab is opened on the internet browser using the computing device 102 by the user via the network 104, for example, a wireless local area network (WLAN) or Wi-Fi. In an exemplary embodiment, the internet browser could be, but not limited to, Google chrome. At step 406, the user navigates a website page or a web form to retrieve or copy data using the computing device 102 via the network 104. At step 408, several new windows or tabs are opened on the internet browser by the user. At step 410, the user navigates a different website page or tab in each new browser window or tab and that may also display a web form where data needs to be filled. In an exemplary embodiment, the web pages such as, but not limited to, eBay, Etsy, etc. At step 412, the user clicks on an icon or image of the browser extension to display a menu with multiple options. Further at step 414, the user selects an option that will then copy data from the internet browser window that holds data and paste on the website page or web form which is displayed on the several website pages or web forms where data needs to be entered or filled by the user with minimum user interventions.

Preferred embodiments of this invention are described herein, including the best mode known to the inventors for carrying out the invention. It should be understood that the illustrated embodiments are exemplary only and should not be taken as limiting the scope of the invention.

The foregoing description comprise illustrative embodiments of the present invention. Having thus described exemplary embodiments of the present invention, it should be noted by those skilled in the art that the within disclosures are exemplary only, and that various other alternatives, adaptations, and modifications may be made within the scope of the present invention. Merely listing or numbering the steps of a method in a certain order does not constitute any limitation on the order of the steps of that method. Many modifications and other embodiments of the invention will come to mind to one skilled in the art to which this invention pertains having the benefit of the teachings in the foregoing descriptions. Although specific terms may be employed herein, they are used only in generic and descriptive sense and not for purposes of limitation. Accordingly, the present invention is not limited to the specific embodiments illustrated herein.

What is claimed is:

1. A system for adding data to a web form on a website, comprising:
an internal or external data storage center having a server;
a processor in communication with the server, configured to execute a set of instructions stored in a memory, wherein the memory is in communication with the processor,
a database in communication with the server configured to store data related to a user; and
a computing device configured to access the server via a network and a browser extension for receiving data and automatically adding the retrieve data and filling the web forms with a text, images and files from one website to another website by the user with minimum user interventions.

2. The system of claim 1, wherein the computing device is in communication with the server, wherein such communication is established via the browser extension.

3. The system of claim 1, wherein the browser extension is designed and coded using a JavaScript, a cascading style sheets (CSS), hypertext markup language (HTML) and any combination thereof to interact with the web forms of websites.

4. The system of claim 1, wherein the browser extension is configured to display a menu with multiple options.

5. The system of claim 1, is further configured to enable the user to select an option from the displayed menu on the computing device to copy data from a browser window/tab and fill the web form displayed in another browser window/tab by pasting data.

6. The system of claim 1, wherein the computing device is at least any one of a smartphone, a laptop, a computer, a tablet, a mobile phone, or other suitable mobile and/or handheld electronic devices.

7. The system of claim 1, wherein the network is at least one of a Wi-Fi, a WiMAX network, a local area network (LAN), a wide area network (WAN), and a wireless local area network (WLAN).

8. A method for adding data to a web form on a website using a system, wherein the system comprising an internal or external data storage center having a server, a processor with a memory, and a database, wherein the method comprising the steps of:
accessing a computing device with an internet connection;
navigating the storage location to find installation files of a browser extension;
installing and activating the browser extension by a user;
opening an internet browser on the computing device and navigating a website page or a web form to retrieve data related to the user using the computing device via a network;
opening another new browser window and navigating another website page or a web form where data needs to be filled;
clicking on an icon or image of the browser extension to display a menu with multiple options by the user;
selecting an option from the menu to copy data from the internet browser window that holds data and paste on the website page or a web form displayed on the new browser window or tab where data needs to be filled.

9. The method of claim 8, wherein the computing device is in communication with the server, wherein such communication is established via the browser extension.

10. The method of claim 8, wherein the browser extension is designed and coded using a JavaScript, a cascading style sheets (CSS), hypertext markup language (HTML) and any combination thereof to interact with the web forms of websites.

11. The method of claim 8, wherein the computing device is at least any one of a smartphone, a laptop, a computer, a tablet, a mobile phone, or other suitable mobile and/or handheld electronic devices.

12. The method of claim 8, wherein the network is at least one of a Wi-Fi, a WiMAX network, a local area network (LAN), a wide area network (WAN), and a wireless local area network (WLAN).

13. The method of claim 8, wherein the system is further configured to enable the user to select an option from the menu to copy data from a browser window/tab and fill the web form displayed on another browser window/tab by pasting data.

14. A method for adding data to a web form on a website using a system, wherein the system comprising an internal or external data storage center having a server, a processor with a memory, and a database, wherein the method comprising the steps of:
accessing a computing device with an internet connection;
navigating the storage location to find installation files of a browser extension;
installing and activating the browser extension by a user;
opening an internet browser on the computing device and navigating a website page or a web form to retrieve data related to the user using the computing device via a network;
opening several new browser windows and navigating another website pages or web forms where data needs to be filled;
clicking on an icon or image of the browser extension to display a menu with multiple options by the user;
selecting an option from the menu to copy data from the internet browser window that holds data and paste on the website page or a web form displayed on the several new browser windows or tabs where data needs to be filled.

15. The method of claim 14, wherein the computing device is in communication with the server, wherein such communication is established via the browser extension.

16. The method of claim 14, wherein the browser extension is designed and coded using a JavaScript, a cascading style sheets (CSS), hypertext markup language (HTML) and any combination thereof to interact with the web forms of websites.

17. The method of claim 14, wherein the computing device is at least any one of a smartphone, a laptop, a computer, a tablet, a mobile phone, or other suitable mobile and/or handheld electronic devices.

18. The method of claim 14, wherein the network is at least one of a Wi-Fi, a WiMAX network, a local area network (LAN), a wide area network (WAN), and a wireless local area network (WLAN).

19. The method of claim 14, wherein the system is further configured to enable the user to select an option from the menu to copy data from a browser window/tab and fill the web forms displayed on the several browser windows/tabs by pasting data.
